(19) United States
(12) Patent Application Publication
(10) Pub. No.: US 2026/0251087 A1
(43) Pub. Date: Aug. 27, 2026

(54) Spark Plug, Spark Plug Sleeve And Spark Plug Assembly For A Gas Engine

(71) Applicant: Caterpillar Energy Solutions GmbH, Mannheim (DE)

(72) Inventors: Inigo Guisasola, Landau (DE); Olaf Berger, Dudenhofen (DE); Friedrich Schaefer, Edenkoben (DE)

(21) Appl. No.: 19/159,946

(22) PCT Filed: Mar. 4, 2024
(86) PCT No.: PCT/EP2024/025101

§ 371 Date: Aug. 26, 2025

(30) Foreign Application Priority Data
Mar. 8, 2023 (GB) 2303407.7

(51) Int. Cl. F02B 19/12; H01T 13/08; H01T 13/54

(52) U.S. Cl. CPC F02B 19/12; H01T 13/08; H01T 13/54

(57) ABSTRACT

A spark plug for a gas engine, comprising a seating surface of a tapered shape, a first thread and a second thread, wherein the seating surface is interposed between the first thread and the second thread.

### TECHNICAL FIELD

The present invention relates to internal combustion engines running on gaseous fuel which are equipped with a spark plug, in particular a pre-chamber spark plug, and a spark plug sleeve. Further, the present invention relates to a spark plug assembly, in particular to a pre-chamber spark plug assembly, comprising such a spark plug and such a spark plug sleeve.

### TECHNOLOGICAL BACKGROUND

To achieve favorable combustion conditions during operation of a gas engine, it is known to employ pre-combustion chambers within cylinders of the engine. This particular applies to large-bore engines and engines which combust lean fuel air mixtures. Typically, in such a configuration, an air fuel mixture enters the pre-combustion chamber during a compression stroke of an associated cylinder which is then ignited by a spark plug. By doing so, a flame front is generated which propagates from the pre-combustion chamber via flow transfer channels into a main combustion chamber of the associated cylinder, thereby enabling to consistently burn the air fuel mixture present in the main combustion chamber.

For such gas engine configurations, the use of components referred to as “pre-chamber spark plugs” is known in which the function of a pre-chamber and a spark plug are combined in a single unit. Typically, such pre-chamber spark plugs are arranged at a cylinder head of an engine such that a tip forming a pre-chamber projects into and is fluid-communicatively connected to a main combustion chamber of an associated cylinder.

Further, for mounting the pre-chamber spark plugs to the cylinder head, the use of spark plug sleeves, also referred to as “mounting sleeves”, is known. These sleeves, which preferably are made of a metal material, may ensure proper installation and may serve to remove heat from the pre-chambers spark plugs during operation of the engine. In the context of the present disclosure, an assembly comprising a spark plug and a spark plug sleeve is referred to as a “spark plug assembly”. Further, an assembly comprising a spark plug sleeve and a pre-chamber spark plug or a spark plug and a separate pre-chamber is referred to as a “pre-chamber spark plug assembly”.

Typically, a requirement for such pre-chamber spark plug assemblies is to ensure tightness and proper heat conduction between the pre-chamber spark plug and the spark plug sleeve during operation.

### SUMMARY OF THE INVENTION

Starting from the prior art, it is an objective to provide an improved spark plug, in particular an improved pre-chamber spark plug, and an improved spark plug sleeve, which in particular contribute to an improved tightness or heat flow within spark plug assembly. Further, it is an objective to provide an improved spark plug assembly, in particular an improved pre-chamber spark plug assembly, comprising such spark plug and such a spark plug sleeve.

These objectives are solved by the subject matter of the independent claims. Preferred embodiments are set forth in the present specification, the Figure as well as the dependent claims.

Accordingly, a spark plug, in particular a pre-chamber spark plug, for a gas engine is provided. The spark plug comprises a seating surface of a tapered shape, a first thread and a second thread, wherein the seating surface is interposed between the first thread and the second thread.

Further, a spark plug sleeve is provided for mounting such a spark plug on a gas engine. The spark plug sleeve comprises a further seating surface of a tapered shape, a further first thread and a further second thread, wherein the further seating surface is interposed between the further first thread and the further second thread.

Still further, a spark plug assembly, in particular a pre-chamber spark plug assembly, for a gas engine is provided. The spark plug assembly comprises a spark plug, in particular a pre-chamber spark plug, and a spark plug sleeve as described above, wherein the spark plug is received within the spark plug sleeve such that the first thread is engaged with the further first thread, the second thread is engaged with the further second thread, and that the seating surface abuts on the further seating surface.

The spark plug assembly may comprise a pre-chamber spark plug and/or a spark plug without a pre-chamber and/or a separate pre-chamber.

As the proposed spark plug, the proposed spark plug sleeve and the proposed spark plug assembly are functionally and structurally interlinked to one another, technical features described hereinafter with regard to one of these components correspondingly applies and is thus to be regarded as being also disclosed for the other components.

### BRIEF DESCRIPTION OF THE DRAWINGS

The present disclosure will be more readily appreciated by reference to the following detailed description when being considered in connection with the accompanying drawings in which:

FIG. 1 depicts a longitudinal view of a spark plug assembly according to an embodiment.

### DETAILED DESCRIPTION OF PREFERRED EMBODIMENTS

In the following, the invention will be explained in more detail with reference to the accompanying FIGURE.

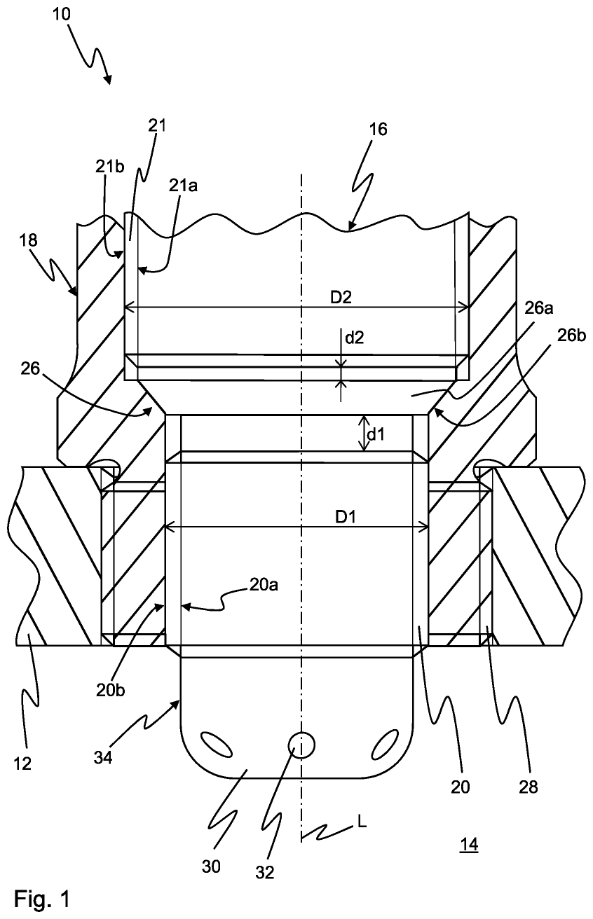

FIG. 1 depicts a spark plug assembly in the form of a pre-chamber spark plug assembly 10, which is referred to as the “pre-chamber assembly” in the following. The pre-chamber assembly 10 is, at least partly, received in and mounted to a cylinder head 12 of an internal combustion engine, also referred to as “the engine” in the following. The engine preferably is a gas engine. In the context of the present disclosure, the term “gas engine” generally refers to any internal combustion engine which runs on gaseous fuel, such as natural gas, biogas, etc. The use of the suggested pre-chamber assembly 10 is not limited to engines of a specific application, but rather may be applied among different technical fields, such as gas engines used in power plants or vehicles as a main or auxiliary engine or the like.

The engine, which employs the suggested pre-chamber assembly 10, preferably comprises a plurality of cylinders, e.g., four, eight, twelve or eighteen cylinders. The cylinders may be provided in an engine block and are delimited from above by at least one cylinder head 12. In general, the cylinder head 12 refers to a component of the engine which preferably is fixed to the engine block and which partly delimits one or more combustion chambers 14 in the cylinders of the engine, also referred to as “main combustion chambers” in the following.

Preferably, the engine is equipped with a plurality of pre-chamber assemblies 10, each of which is associated to a different one of the plurality of cylinders. In other words, one pre-chamber assembly 10 is provided per cylinder of the engine.

In the following, the structural and function configuration of the pre-chamber assembly 10 is described with reference to the embodiment depicted in FIG. 1 which may apply to one or more, preferably to all, of the plurality of pre-chamber assemblies 10 employed in the engine.

The pre-chamber assembly 10 comprises a pre-chamber spark plug 16 and a spark plug sleeve 18, which is referred to as the “sleeve” hereinafter. Alternatively, the pre-chamber assembly may be a spark plug assembly comprising a spark plug without a pre-chamber and/or with a separate pre-chamber. The pre-chamber spark plug 16 is, at least partly, received within the sleeve 18 and is fixed or attached thereto, inter alia, by a first threaded connection 20 and second threaded connection 21. Specifically, the pre-chamber spark plug 16 is received within the sleeve 18 such that a seating surface 26a of the pre-chamber spark plug 16 abuts on a further seating surface 26b of the sleeve 18. By this configuration, the seating surface 26a and the further seating surface 26b form a seating 26 between the pre-chamber spark plug 16 and the sleeve 18. The sleeve 18, in turn, is fixed to the cylinder head 12 by a third threaded connection 28.

The pre-chamber spark plug 16 and the sleeve 18 extend along a longitudinal axis L of the pre-chamber assembly 10. The longitudinal axis L of the pre-chamber assembly 10 coincides with a middle longitudinal axis of the spark plug 16 and a middle longitudinal axis of the sleeve 18. Accordingly, the middle longitudinal axis of the spark plug 16 coincides with the middle longitudinal axis of the sleeve 18.

The pre-chamber spark plug 16 is provided to combine the function of a pre-combustion chamber and the function of an ignition element, in particular a spark plug, in a single unit, which is preferably assembled from several parts. As such, the pre-chamber spark plug 16 includes a pre-combustion chamber and a spark plug (not shown). The pre-combustion chamber is formed by a pre-chamber cap 30 provided at a tip end of the pre-chamber spark plug 16. In the mounted state of the pre-chamber spark plug assembly 10, as depicted in FIG. 1, the pre-chamber cap 30 protrudes into the main combustion chamber 14 and is fluid-communicatively connected to the main combustion chamber 14 via a plurality of flow transfer channels 32.

By this configuration, during operation of the engine, an air fuel mixture may enter the pre-combustion chamber within the pre-chamber cap 30 via the flow transfer channels 32, in particular during a compression stroke, which then may be ignited by a spark generated by the ignition element of the pre-chamber spark plug 16. By doing so, a flame front may propagate from the pre-combustion chamber via the flow transfer channels 32 into the main combustion chamber 14, thereby combusting the air fuel mixture present in the main combustion chamber 14.

According to one configuration, the pre-chamber spark plug 16 may be designed such that the air fuel mixture soaked into the pre-combustion chamber during the intake stroke is enriched by supplying gaseous fuel into the pre-combustion chamber via a separate fuel feed passage. According to an alternative configuration, such a separate fuel feed passage may be omitted such that the air fuel mixture soaked into the pre-combustion chamber is ignited without being enriched by additional fuel.

The pre-chamber spark plug 16 may comprise different portions, which may subdivide the pre-chamber spark plug 16 into different sections, in particular along the longitudinal axis L. For example, in the shown configuration, the pre-chamber spark plug 16 may be subdivided into a tip portion 34 and a rear portion (not shown). The tip portion 34 is arranged in a lower section or lower half of the pre-chamber spark plug 16 facing the main combustion chamber 14.

As can be gathered from FIG. 1, at the tip portion 34, the pre-chamber cap 30, the first threaded connection 20, the second threaded connection 21 and the seating 26 are provided. As such, the tip portion 34 comprises the pre-combustion chamber.

Generally, in the context of the present disclosure, the terms “lower”, “bottom”, etc., refer to a location or section of a component which faces or is arranged adjacent to or in the vicinity of the associated cylinder, i.e. the associated main combustion chamber 14, of the engine. Accordingly, the term “below” is used hereinafter to denote a direction along the longitudinal axis L pointing from a rear end of the pre-chamber spark plug assembly 10 towards the associated cylinder or main combustion chamber 14 of the engine, whereas the term “above”, “upward”, etc. refer to an opposite direction.

The sleeve 18 serves to ensure proper installation of the pre-chamber spark plug 16 at the engine, in particular at its cylinder head 12. In addition, the sleeve 18 may be provided to ensure that, during operation of the engine, a sufficiently high heat flow can be transferred from the pre-chamber spark plug 16 to the sleeve 18 so as to prevent the pre-chamber spark plug 16 from being subjected to excessive thermal loads. For doing so, the sleeve 18 preferably is mad of a metal material.

The basic structural and functional configuration of such a pre-chamber assembly 10, in particular of its pre-chamber spark plug 16 and sleeve 18, are well known to a person skilled in the art and are thus not further described in the present disclosure. Rather, technical features relating to the connection between the pre-chamber spark plug 16 and the sleeve 18, i.e. relating to the force and form closure therebetween, are specified in the following which are interlinked with the present invention. Although not further described hereinafter, the skilled person understands that the pre-chamber spark plug 16 may comprise additional components, such as, insulators, electrodes, fuel supply passages, etc.

As can be gathered from FIG. 1, in a mounted state in which the pre-chamber spark plug 16 is received within and fixed to the sleeve 18, the pre-chamber spark plug 16 and the sleeve 18 are engaged, inter alia, to one another via at least the first threaded connection 20, the second threaded connection 21 and the seating 26.

For doing so, the pre-chamber spark plug 16 comprises a first thread 20a, a second thread 21a, and a seating surface 26a. Accordingly, the sleeve 18 comprises a further first thread 20b, a further second thread 21b and a further seating surface 26b. The first thread 20a and the further first thread 20b are designed correspondingly to one another and are configured to, when being engaged, form the first threaded connection 20. The second thread 21a and the further second thread 21b are designed correspondingly to one another and are configured to, when being engaged, form the second threaded connection 21. The seating 26 is formed at least by the seating surface 26a and the further seating surface 26b which in particular are designed correspondingly to one another.

The first thread 20a and the second thread 20b may be machined at the pre-chamber spark plug 16 during one machining step, i.e. may be produced simultaneously, by using a special tool. The same applies to the further first thread 20b and the further second thread 21b of the sleeve 18.

The seating surface 26a and the further seating surface 26b are of a tapered shape, i.e. have a tapered shape. In other words, each one of the seating surface 26a and the further seating surface 26b has a shape that narrows along the longitudinal axis L. Specifically, each one of the seating surface 26a and the further seating surface 26b narrows, i.e. its diameter decreases, along the longitudinal direction pointing from the rear portion to the pre-chamber cap 30 of the pre-chamber spark plug 16.

More specifically, in the shown configuration, each one of the seating surface 26a and the further seating surface 26b has a conical shape. In the context of the present disclosure, the term “conical shape” refers to a shape that follows or represents at least a part of a shell surface of a cone. As such, the conical shape may refer to a shape that follows or represents the shell surface of a cone or truncated cone. However, the shape of the seating surface 26a or the further seating surface 26b is not limited to a conical shape, but rather may be of any suitable tapered shape. Specifically, the tapered shape may be a continuously narrowing shape, e.g. having a curved shape or curved shell surface, or a gradually narrowing shape, e.g. having a stepped shape or stepped shell surface. In the context of the present disclosure, the seating 26 refers to or includes a contact surface between the seating surface 26a and the further seating surface 26b. Thus, the technical features described in the present disclosure with regard to the seating surface 26a and the further seating surface 26b, which are designed correspondingly to one another, also apply to the seating 26. As such, the seating 26 has a tapered shape, in particular a conical shape.

In a further development, the seating surface 26a and/or the further seating surface 26b may be provided with a circumferential groove, i.e. extending around the longitudinal axis L. By this configuration, tightness of the connection between the pre-chamber spark plug 16 and the sleeve 18 may be improved.

Further, in the circumferential groove, a sealing element, such as an O-ring or sealing tape, and/or a heat conducting component, such as a heat conducting paste, may be arranged.

As can be gathered from FIG. 1, the pre-chamber spark plug assembly 10 is provided such that the seating 26 is interposed between the first threaded connection 20 and the second threaded connection 21. Accordingly, in the pre-chamber spark plug 16, the seating surface 26a is interposed between the first thread 20a and the second thread 21a and, in the sleeve 18, the further seating surface 26b is interposed between the further first thread 20b and the further second thread 21b.

It has been found that, by this configuration, the contact area and contact surface between the components of the pre-chamber spark plug assembly 10 may be increased and may thereby contribute to an improved sealing and an increased heat transfer between the components, i.e. between the pre-chamber spark plug 16 and the sleeve 18.

In the following, the structural arrangement, in particular the relative structural arrangement, of the seating 26, the first threaded connection 20 and the second threaded connection 21 is further specified. The technical features described in this context correspondingly apply to the structural arrangement of the seating surface 26a, the first thread 20a and the second thread 21a, as well as to the further seating surface 26b, the further first thread 20b and the further second thread 21b relative to one another.

Specifically, the first threaded connection 20 has a first diameter D1 that is smaller than a second diameter D2 of the second threaded connection 21. Accordingly, each one of the first thread 20a and the further first thread 20b has the first diameter D1 that is smaller than the second diameter D2 of the second thread 21a and the further second thread 21b.

Further, along the longitudinal axis L, the first threaded connection 20 and the second threaded connection 21 are arranged in the area of, i.e. in the vicinity of, opposing sides of the seating 26. Specifically, the first threaded connection 20 is arranged below and the second threaded 21 connection is arranged above the seating 26. Accordingly, along the longitudinal axis L of the pre-chamber spark plug 16, the first thread 20a and the second thread 21a are arranged in the area of opposing sides of the seating surface 26a. Further, along the longitudinal axis L of the sleeve 18, the further first thread 20b and the further second thread 21b are arranged in the area of opposing sides of the further seating surface 26b.

As can be gathered from FIG. 1, the first threaded connection 20, the second threaded connection 21 and the seating 26 are arranged at the tip portion 34 of the pre-chamber spark plug 16 and the sleeve 18. As such, the first threaded connection 20, the second threaded connection 21 and the seating 26 are arranged in the same half of the pre-chamber assembly 10, i.e. in its bottom half. In other words, the first threaded connection 20, the second threaded connection 21 and the seating 26 are arranged within a tip half, which may also be referred to as bottom half, of the pre-chamber spark plug 16 or the pre-chamber assembly 10 which faces and at least partly protrudes into the main combustion chamber 14. The tip half may extend along half of a total length of the pre-chamber spark plug 16 or the pre-chamber assembly 10 along its longitudinal axis L. Accordingly, the first thread 20a and the second thread 21a are arranged within the tip portion 34 of the pre-chamber spark plug 16. Further, the further first thread 20b and the further second thread 21b are arranged within a tip portion of the sleeve 18.

Each one of the first threaded connection 20 and the second threaded connection 21 is arranged at a distance from the seating 26, which is smaller than the first and the second diameter D1, D2. As can be gathered from FIG. 1, the first and the second diameter D1, D2 extend perpendicular to the longitudinal axis L. More specifically, the first thread 20a is arranged at a first distance d1 from the seating surface 26a and the second thread 21a is arranged at a second distance d2 from the seating surface 26a, and wherein each one of the first distance d1 and the second distance d2 is smaller than a diameter D1 of the pre-chamber spark plug 16 at the seating surface 26a. Further, the further first thread 20b is arranged at the first distance d1 from the further seating surface 26b and the further second thread 21b is arranged at the second distance d2 from the further seating surface 26b, and wherein each one of the first distance d1 and the second distance d2 is smaller than a diameter D1 of the sleeve 18 at the further seating surface 26b.

In the shown configuration, the first distance dl is greater than the second distance d2. According to an alternative embodiment, the first distance d1 may be equal to or smaller than the second distance d2. Further, in the shown configuration, each one of the first distance d1 and the second distance d2 is smaller than one quarter of the diameter D1 and D2. According to an alternative embodiment, each one of the first distance d1 and the second distance d2 may be smaller than the first diameter D1 or the second diameter D2 or smaller than at least one half of the diameter D1 or the diameter D2.

As set forth above, the seating 26 is formed by at least the seating surface 26a of the pre-chamber spark plug 16 and the further seating surface 26b of the sleeve 18. The seating surface 26a is provided at an outer or shell surface of the pre-chamber spark plug 16. Specifically, the seating surface 26a is provided circumferentially around the longitudinal axis L and circumferentially along the outer or shell surface of the pre-chamber spark plug 16. The further seating surface 26b is provided at an inner surface of the sleeve 18, in particular circumferentially around its longitudinal axis L and circumferentially along the inner surface of the sleeve 18.

The seating 26 serves for proper installation of the pre-chamber spark plug 16 within the sleeve 18. As such, the seating 26 may have, inter alia, the function of a sealing to establish tightness between the components of the pre-chamber assembly 10. Accordingly, the seating 26 may also be referred to as a sealing or sealing seat. Further, the seating 26 preferably serves to transfer heat between the components during operation of the engine, e.g. to protect the pre-chamber spark plug 16 from overheating.

Compared to configurations of a pre-chamber spark plug assembly, in which a threaded connection is merely provided at a rear end or rear portion of the pre-chamber spark plug assembly, but not in the vicinity of a seating, it has been found that the suggested arrangement may improve pressure distribution at the seating 26 and thus tightness and heat conduction characteristics of the suggested assembly.

Further, as can be gathered from FIG. 1, the first threaded connection 20 and the third threaded connection 28 overlap in a direction along the longitudinal axis L. In other words, the first threaded connection 20 and the third threaded connection 28 are arranged at the same height or level with regard to the longitudinal axis L. This arrangement is achieved by providing the sleeve 18 with a hollow-cylindrical shape at its bottom portion, i.e. the portion of the sleeve 18 facing the main combustion chamber 14, which is provided with an internal thread, i.e. the further first thread 20b, and an external thread. As can be gathered from FIG. 1, the external thread is configured to engage with a thread provided at an inner surface of a receiving aperture of the cylinder head 12 which together form the third threaded connection 28. In other words, the external thread is configured to form the third threaded connection 28 between the sleeve 18 and a cylinder head 12 of the engine.

More specifically, the sleeve 18 is designed such that its inner thread, i.e. the further first thread 20b, and its external thread extend from a bottom end of the sleeve 18 in an upward direction along the longitudinal axis, i.e. in a direction along the longitudinal axis L which faces away from the main combustion chamber 14. Further, the inner thread, i.e. the further first thread 20b, and the external thread overlap in a direction along the longitudinal axis L. In the shown configuration, the inner thread, i.e. the further first thread 20b, extends beyond the external thread of the sleeve 18 in the upward direction.

It will be obvious for a person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention. This is in particular the case with respect to the following optional features which may be combined with some or all embodiments, items and/or features mentioned before in any technically feasible combination.

Accordingly, a spark plug, in particular a pre-chamber spark plug, for a gas engine may be provided. The spark plug may comprise a seating surface of a tapered shape, a first thread and a second thread, wherein the seating surface may be interposed between the first thread and the second thread.

Optionally, the seating surface may have a conical shape.

Alternatively or additionally, the first thread may have a first diameter that is smaller than a second diameter of the second thread. Optionally, along a longitudinal axis of the spark plug, the first thread and the second thread may be arranged in the area of opposing sides of the seating surface.

Alternatively or additionally, the first thread and the second thread may be arranged within a tip portion of the spark plug, wherein in particular the tip portion may comprise a pre-combustion chamber.

In a further development, the first thread may be arranged at a first distance from the seating surface and the second thread may be arranged at a second distance from the seating surface. At least one of the first distance and the second distance may be smaller than a diameter of the spark plug at the seating surface.

Furthermore, a spark plug sleeve may be provided for mounting such a spark plug, in particular such a pre-chamber spark plug, on a gas engine. The spark plug sleeve may comprise a further seating surface of a tapered shape, a further first thread and a further second thread, wherein the further seating surface may be interposed between the further first thread and the further second thread.

Optionally, the further seating surface may have a conical shape.

Alternatively or additionally, the further first thread may have a first diameter that is smaller than a second diameter of the further second thread.

Alternatively or additionally, the spark plug may be provided such that, along a longitudinal axis of the spark plug sleeve, the further first thread and the further second thread are arranged in the area of opposing sides of the further seating surface.

Alternatively or additionally, the spark plug may be provided such that, the further first thread and the further second thread are arranged within a tip portion of the spark plug sleeve. Optionally, the further first thread may be arranged within a first distance from the further seating surface, and the further second thread may be arranged at a second distance from the further seating surface, wherein at least one of the first distance and the second distance is smaller than a diameter of the spark plug sleeve at the further seating surface.

In a further development, the spark plug may further comprise an external thread configured to form a threaded connection between the spark plug sleeve and a cylinder head of the engine. Optionally, the further first thread and the external thread may overlap in a direction along the longitudinal axis of the spark plug sleeve.

Furthermore, a spark plug assembly, in particular a pre-chamber spark plug assembly, for a gas engine may be provided. The spark plug assembly may comprise a spark plug, in particular a pre-chamber spark plug, and a spark plug sleeve as described above, wherein the spark plug may be received within the spark plug sleeve such that the first thread is engaged with the further first thread, the second thread is engaged with the further second thread, and that the seating surface abuts on the further seating surface.

### INDUSTRIAL APPLICABILITY

With reference to the FIGURE, a spark plug, a spark plug sleeve and a spark plug assembly for a gas engine are suggested. The spark plug assembly as mentioned above is applicable in any suitable internal combustion engine. The suggested spark plug assembly may replace conventional spark plug assemblies and may serve as a replacement or retrofit part.

1. A spark plug for a gas engine comprising a seating surface of a tapered shape, a first thread and a second thread, wherein the seating surface is interposed between the first thread and the second thread.

2. The spark plug according to claim 1, wherein the seating surface has a conical shape.

3. The spark plug according to claim 1, wherein the first thread has a first diameter that is smaller than a second diameter (D2) of the second thread.

4. The spark plug according to claim 1, wherein along a longitudinal axis (L) of the pre-chamber spark plug, the first thread and the second thread are arranged in the area of opposing sides of the seating surface.

5. The spark plug according to claim 1, wherein the first thread and the second thread are arranged within a tip portion of the spark plug, wherein in particular the tip portion comprises a pre-combustion chamber.

6. The spark plug according to claim 1, wherein the first thread is arranged at a first distance (d1) from the seating surface, wherein the second thread is arranged at a second distance (d2) from the seating surface, and wherein each one of the first distance (d1) and the second distance (d2) is smaller than a diameter (D1) of the pre-chamber spark plug at the seating surface.

7. A spark plug sleeve for mounting a spark plug according to claim 1 on a gas engine, comprising a further seating surface of a tapered shape, a further first thread and a further second thread, wherein the further seating surface is interposed between the further first thread and the further second thread.

8. The spark plug sleeve according to claim 7, wherein the further seating surface has a conical shape.

9. The spark plug sleeve according to claim 7, wherein the further first thread has a first diameter (D1) that is smaller than a second diameter (D2) of the further second thread.

10. The spark plug sleeve according to claim 7, wherein along a longitudinal axis (L) of the spark plug sleeve, the further first thread and the further second thread are arranged in the area of opposing sides of the further seating surface.

11. The spark plug sleeve according to claim 7, wherein the further first thread and the further second thread are arranged within a tip portion of the spark plug sleeve.

12. The spark plug sleeve according to claim 7, wherein the further first thread is arranged within a first distance (d1) from the further seating surface, wherein the further second thread is arranged at a second distance (d2) from the further seating surface, and wherein each one of the first distance (d1) and the second distance (d2) is smaller than a diameter (D1) of the spark plug sleeve at the further seating surface.

13. The spark plug sleeve according to claim 7, further comprising an external thread configured to form a threaded connection between the spark plug sleeve and a cylinder head of the engine.

14. The spark plug sleeve according to claim 13, wherein the further first thread and the external thread overlap in a direction along the longitudinal axis (L) of the spark plug sleeve.

15. A spark plug assembly for a gas engine comprising a spark plug according to claim 1 and a spark plug sleeve according to claim 7, wherein the spark plug is received within the spark plug sleeve such that the first thread is engaged with the further first thread, the second thread is engaged with the further second thread, and that the seating surface abuts on the further seating surface.
